(19) United States
(12) Patent Application Publication
(10) Pub. No.: US 2007/0181266 A1
(43) Pub. Date: Aug. 9, 2007

(54) Blind fixing core

(75) Inventors: Yu Che Wen, Taichung (TW); Tung Jung Chen, Taichung (TW); Ju Sheng Cheng, Taichung (TW)

Correspondence Address: BRUCE H. TROXELL, SUITE 1404, 5205 LEESBURG PIKE, FALLS CHURCH, VA, 22041, US

(73) Assignee: Nien Made Enterprise Co., Ltd.

(21) Appl. No.: 11/346,354

(22) Filed: Feb. 3, 2006

(51) Int. Cl. E06B 9/307

(52) U.S. Cl. 160/177 R

(57) ABSTRACT

A blind fixing core has its upper portion axially formed integral with two ladder cord slots and two ladder strap slots. The two ladder cord slots are positioned in the upper center of the fixing core and their slot pitches are gradually contracted toward the rear ends that are respectively expanded to form a positioning hole. The two ladder strap slots are respectively positioned at the outer sides of the two ladder cord slots and have their lower sides respectively provided with a positioning rod. The two ladder strap slots further have their opening ends respectively extending inward horizontal to form a position-limiting hook. The fixing core of this invention can be assembled thereon with both ladder cords and ladder straps, increasing adaptability of blind fixing cores.

### BACKGROUND OF THE INVENTION

1. Field of the Invention

This invention relates to a blind fixing core, particularly to one having its upper portion axially formed integral with two ladder cord slots and two ladder strap slots so that the fixing core can be applied to different kinds of blinds linked by ladder cords or by ladder straps.

2. Description of the Prior Art

A conventional blind usually has the opposite sides of its slats-respectively linked by a ladder cord or by a ladder strap and has two ends of the ladder cord or the ladder strap fixed with the fixing core positioned on the upper rail of the blind. The fixing core can be controlled by a rotating shaft to rotate and actuate the ladder cords or the ladder straps to move bias and synchronously turn the slats of the blind for a preset angle so as to adjust the extent of sunshine.

However, the fixing core of the conventional blind is provided with one single kind of ladder cord slot or ladder strap slot, but ladder cord and ladder strap are different in structure and their fixing slots are different in shape; therefore, only one kind of fixing slot cannot be applied to both ladder cord and ladder strap at the same time. In this case, if different kinds of blinds linked by ladder cords or by ladder straps are to be assembled, two different kinds of fixing cores with different-shaped fixing slots have to be prepared, thus increasing cost of remaining goods. In addition, these two different kinds of fixing cores can hardly be exchanged with each other for use. If a blind already assembled is to have its fixing slots replaced with different ones, its original fixing core also has to be replaced, increasing cost in replacing of blinds.

### SUMMARY OF THE INVENTION

The objective of the invention is to offer a blind fixing core having its upper portion axially formed integral with two ladder cord slots and two ladder strap slots. The two ladder cord slots are positioned in the center of the fixing core, having their slot pitch gradually contracted toward the rear end and their rear ends respectively expanded to form a positioning hole for fixing a ladder cord therein. The two ladder strap slots respectively positioned at the outer sides of the two ladder cord slots are long, having their front ends respectively formed with an opening end and their lower sides respectively and oppositely disposed with a positioning rod for fitting a ladder strap thereon. Further, the two ladder strap slots have their opening ends respectively extending inward horizontally to form a position-limiting hook for restricting and fixing a ladder strap. By so designing, the blind fixing core of this invention can be applied to different blinds linked by ladder cords or by ladder straps, needless to prepare various kinds of fixing cores for assembling different blinds, and able to reduce amount and cost of remaining goods and elevate adaptability of blind fixing cores.

### BRIEF DESCRIPTION OF DRAWINGS

This invention will be better understood by referring to the accompanying drawings, wherein:

FIG. 1 is a perspective view of a blind fixing core in the present invention;

FIG. 2 is an exploded perspective view of the blind fixing core in the present invention;

FIG. 3 is a perspective view of the blind fixing core having ladder cords fixed thereon in the present invention;

FIG. 4 is a side cross-sectional view of the blind fixing core having ladder cords fixed thereon in the present invention; and

FIG. 5 is a perspective view of the blind fixing core having ladder straps fixed thereon in the present invention.

### DETAILED DESCRIPTION OF THE PREFERRED EMBODIMENT

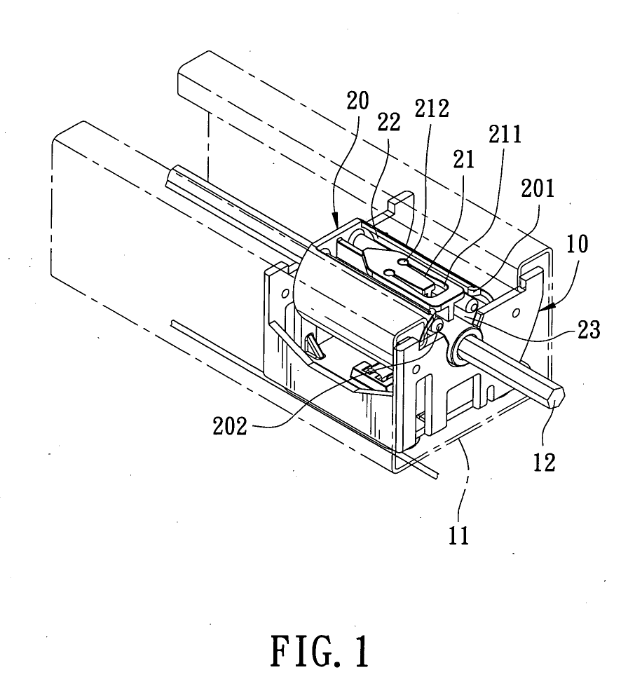

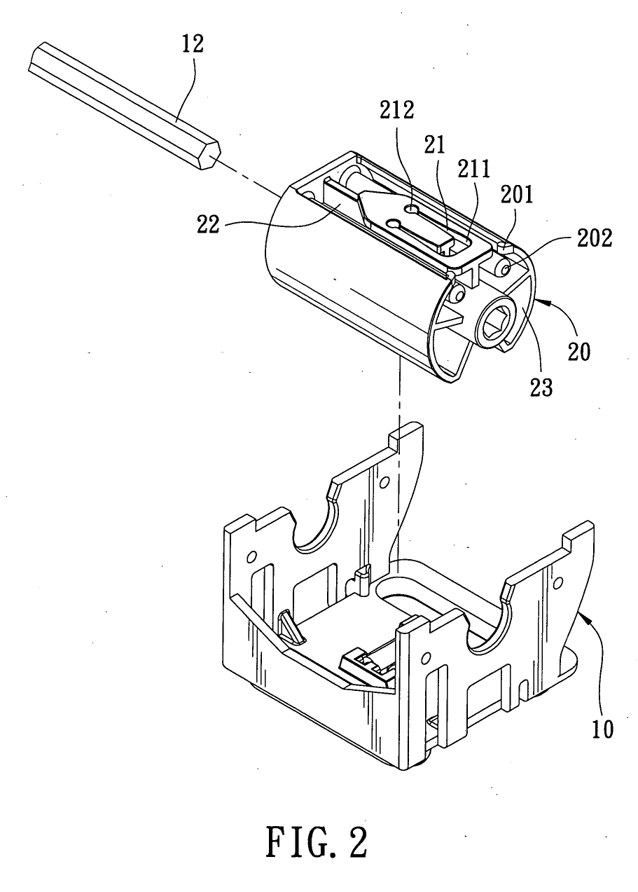

A preferred embodiment of a blind fixing core, as shown in FIGS. 1 and 2, includes a fixing holder 10 and a fixing core 20. The fixing holder 10 is firmly assembled on the upper rail 11 of a blind and the fixing core 20 is pivotally mounted on the fixing holder 10. The fixing core 20 and the fixing holder 10 are pivotally connected with a shaft 12 that can be controlled to rotate and actuate the fixing core 20 to turn for a preset angle.

The fixing core 20 has its upper portion axially formed integral with two ladder cord slots 21 and two ladder strap slots 22 and its front side bored with an opening 23. The two ladder cord slots 21 are positioned in the center of the upper front end of the fixing core 20 and have their front ends connected with each other by a connecting slot 211 to form a closed U-shaped slot. The slot pitch of the ladder cord slot 21 is gradually contracted toward the rear side opposite to the connecting slot 211, and the ends of the two ladder cord slots 21 are respectively expanded to form a positioning hole 212. The two ladder strap slots 22 are long, respectively positioned at the opposite outer sides of the two ladder cord slots 21 and respectively having an opening end formed at the location of the front opening 23 of the fixing core 20. In addition, the two ladder strap slots 22 have their opening ends respectively extending inward horizontally to form a position-limiting hook 201 and their lower sides respectively disposed with a positioning rod 202 formed with a free end at the same side of the opening end of the ladder strap slot 22.

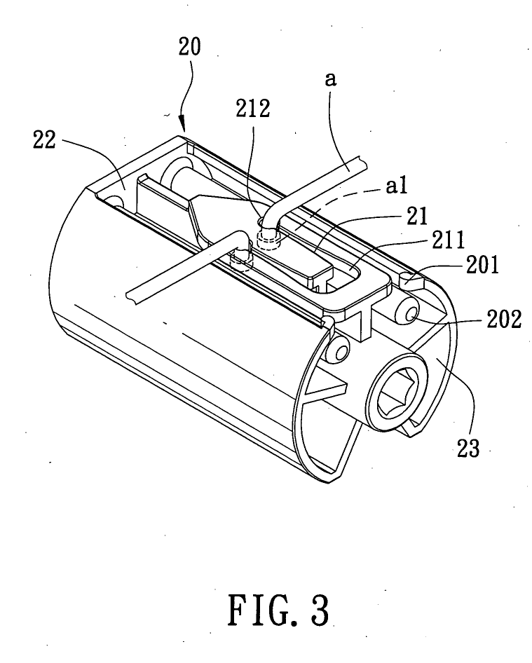

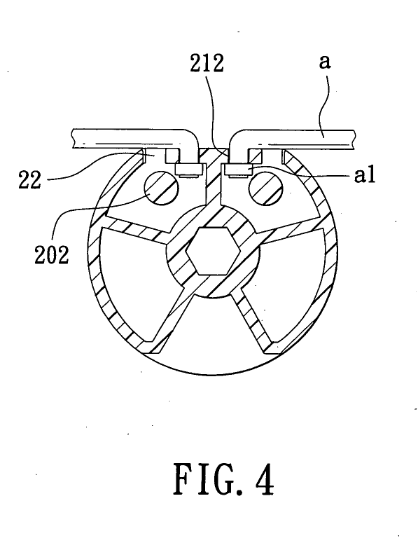

To assemble two ladder cords (a) on the fixing core 20, as shown in FIGS. 3 and 4, the two ladder cords (a) are respectively fitted in the positioning holes 212 through the connecting slot 211 and along the ladder cord slot 21. Since the slot pitch of the ladder cord slot 21 is gradually contracted and becomes smaller than the sectional area of the ladder cord (a), the two ladder cords (a) can be respectively restricted and positioned in the two positioning holes 212. Next, the two ladder cords (a) have their cord heads respectively pulled out of the ladder cord slots 21 and a retainer (a1) having a sectional area larger than that of the positioning hole 212 is fastened at a preset location of each ladder cord (a) for restricting and firmly fixing the ladder cord (a) in the ladder cord slot 21.

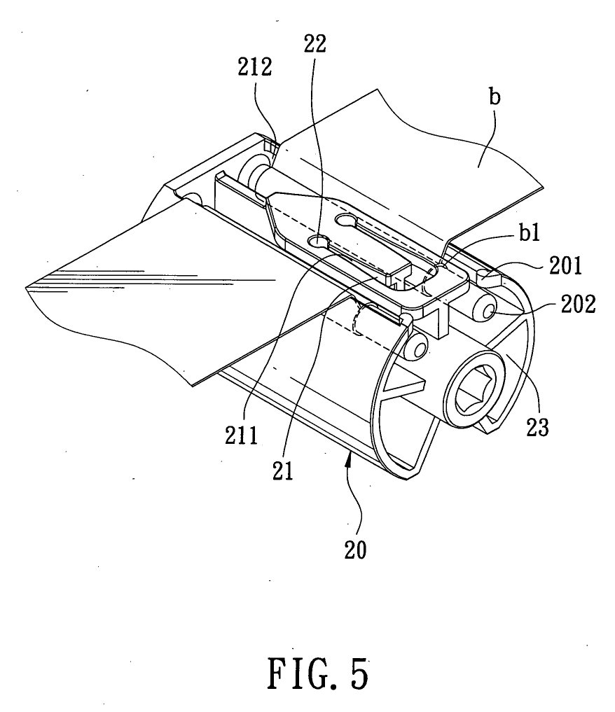

When the ladder straps (b) are to be assembled on the fixing core 20, as shown in FIG. 5, the ladder straps (b), which have their front ends respectively sewed with an ear member (b1), are respectively fitted in the fixing core 20 through the opening ends of the ladder strap slot 22, and the two ear members (b1) of the two ladder straps (b) are respectively fitted on the two positioning rods 202, letting the ladder straps (b) restricted and positioned on the fixing core 20. In addition, the two position-limiting hooks 201 respectively provided at the opening ends of the two ladder strap slots 22 are able to prevent the ladder straps (b) from slipping out of the ladder strap slots 22.

As can be understood from the above description, this invention has the following advantages.

1. The blind fixing core of this invention is formed integral with two ladder cord slots and two ladder strap slots for respectively assembling ladder cords and ladder straps; therefore, one single fixing core of this invention can be applied to different kinds of blinds that are respectively linked by ladder cords or by ladder straps, able to reduce the amount and the cost of remaining goods. In addition, when a blind is to be eliminated or replaced, it is needless to replace or re-position the fixing core, lessening cost and time in replacing of blinds.

2. Both the ladder cord slots and the ladder strap slots are positioned at the upper side of the fixing core, and ladder cords and ladder straps can be assembled on the fixing core at the same side and with the same steps, simple and convenient in assembling.

3. The connecting slot connecting the two ladder cord slots is formed with a comparatively large slot pitch for facilitating ladder cords to be fitted in the ladder cord slot, saving time in assembling.

4. The two ladder strap slots of the fixing core have their opening ends respectively extending inward horizontally to form a position-limiting hook for restricting and fixing a ladder strap in the ladder strap slot so as to prevent the ladder strap from slipping out of the ladder strap slot when it is in use.

While the preferred embodiment of the invention has been described above, it will be recognized and understood that various modifications may be made therein and the appended claims are intended to cover such modifications that may fall within the spirit and scope of the invention.

I claim:

1. A blind fixing core pivotally assembled with the fixing holder on the upper rail of a blind, said fixing core having a shaft inserted in the center, said shaft controlled to rotate and actuate said fixing core to move bias for a preset angle, said fixing core turned to actuate the slats of said blind to be turned for a preset angle:
Said fixing core having its front end bored with an opening and its upper portion axially formed integral with two ladder cord slots and two ladder strap slots, the slot pitch of said ladder cord slot gradually contracted toward the rear end, said rear end of said ladder cord slot expanded to form a positioning hole for fixing a ladder cord therein, said two ladder strap slots respectively positioned at the outer sides of said two ladder cord slots, said ladder strap slot being long and formed with an opening end at the front end of said fixing core, said two ladder strap slots having their lower sides respectively and oppositely disposed with a positioning rod, said positioning rod formed with a free end at the same side of said opening end of said ladder strap slot, said free ends of said positioning rods facilitating ladder straps to be fitted on said positioning rods.

2. The blind fixing core as claimed in claim 1, wherein said ladder strap slots have their opening ends respectively extending inward horizontally to form a position-limiting hook.

3. The blind fixing core as claimed in claim 1, wherein said two ladder cord slots have their front ends opposite to said positioning holes formed with a connecting slot connecting said two ladder cord slots to form a closed U-shaped slot.
